(19) United States
(12) Patent Application Publication
(10) Pub. No.: US 2009/0126705 A1
(43) Pub. Date: May 21, 2009

(54) Heated fuel vaporizer for enhanced cold starting of an internal combustion engine

(76) Inventors: David J. Trapasso, Bloomfield, NY (US); Kenneth J. Dauer, Lima, NY (US); Jason C. Short, Henrietta, NY (US); Daniel F. Kabasin, Rochester, NY (US); John R. Socha, Pavilion, NY (US)

Correspondence Address: DELPHI TECHNOLOGIES, INC., M/C 480-410-202, PO BOX 5052, TROY, MI, 48007, US

(21) Appl. No.: 11/985,591

(22) Filed: Nov. 16, 2007

(51) Int. Cl. F02M 31/125; H05B 3/20

(52) U.S. Cl. 123/549; 392/394

(57) ABSTRACT

A heated fuel vaporizer is disposed in an intake component, such as a throttle valve or an intake manifold, of a fuel injected and spark-ignited internal combustion engine. The engine may be fueled by any liquid fuel, such as gasoline, diesel or by fuels much less volatile than gasoline, for example, alcohols such as ethanol, or mixtures of ethanol and gasoline. A configurable heating element is made from a single piece of sheet metal and includes one or two grids each formed by slots and segments. By controlling the geometry of the element, the power and surface area can be configured to any desired value. A single piece heater assembly is designed for installation in an intake component, such as throttle valve or intake manifold, of an internal combustion engine. The heater assembly includes a single-grid or dual-grid heating element that is over-molded with a high melting temperature polymer.

### TECHNICAL FIELD

The present invention relates to internal combustion engines; more particularly, to means for vaporizing liquid fuels; and most particularly, to heating elements and a heater assembly for generation of fuel vapor to enhance the cold-starting capabilities and overall emission reduction of engines.

### BACKGROUND OF THE INVENTION

Fuel-injected internal combustion engines fueled by liquid fuels, such as gasoline, diesel, and by alcohols, in part or in whole, such as ethanol, methanol, and the like, are well known. As used herein, the term “ethanol” is taken to mean all such forms of alcohol fuels and alcohol/alkane blends.

Internal combustion engines typically rely on having a compressed fuel/air mixture that is combustible in a combustion cylinder. For spark-ignited gasoline-fueled engines, such a condition generally presents little problem except at extremely low temperatures. However, internal combustion engines that are fueled by fuels much less volatile than gasoline, for example, alcohols such as ethanol, or mixtures of ethanol and gasoline, experience fuel vaporization problems in cold temperatures due to a relatively high fuel flash point, also known as vaporization point, as compared to octane or other alkane fuels. For example, ethanol has a flashpoint of about 12.8° C., meaning that ethanol vapor below that temperature may cease to burn when a source of ignition is removed. Thus, starting the engine can be difficult or impossible under temperature conditions experienced seasonally in many parts of the world. The problem is further exacerbated by the presence of water in such mixtures, as ethanol cannot be produced inexpensively as the pure compound but rather distills as a 95/5% ethanol/water azeotrope.

In some geographic areas, for example, Brazil, where many modern vehicles are fueled by pure azeotrope, it is highly desirable to provide some means for enhancing the cold starting capabilities of such vehicles.

Most spark-ignited vehicles currently being produced for consumer use, as opposed to racing or other specialty vehicles, utilize fuel injectors for dispensing fuel into either the runners of an intake manifold (“port injection”) or the cylinders themselves (“direct injection”). There are currently several approaches to aid cold weather starting of ethanol engines. For example, some engines are equipped with an auxiliary gasoline injection system that is utilized under cold start conditions. Another approach to cold starting an ethanol-fueled engine is to heat the fuel or the combustion chamber. This can be done in several ways. One way involves lowering the pressure in the combustion chamber and relying on friction and compression heat to aid ethanol vaporization. A second way is to install a heater in the fuel system, which may heat the liquid fuel before it is injected to assist in vaporization of the subsequently injected fuel. A third way is to spray fuel directly onto a heat source, causing the liquid fuel to vaporize on contact. Besides enhancing cold-starting capabilities of low volatile liquid fuels, fuel vaporization of other liquid fuels, such as gasoline, may enhance the overall emission reduction.

The key to implement the method of spraying fuel directly onto a heat source to cause vaporization is having a suitable heating element that can provide sufficient power and has a large enough surface area to reach an economical vaporization rate at a reasonable cost. Current technologies, such as the application of nickel-chrome-wires, provide a relatively small surface area and, therefore, require a combination of series and parallel wire elements mounted on a frame in order to enable provision of sufficient amount of power. Such heating elements are expensive to manufacture and are subject to quality concerns due to the high number of pieces of wire that must be connected.

Other current technologies, such as thick film technology, may provide the required surface area but often lack the heat flux and, therefore, the relationship of power to surface area may be too low for vaporization of liquid fuels and especially ethanol fuels in internal combustion engines.

Other challenges that are still not satisfactory solved exist in routing wiring to a heater placed in the air intake components of an internal combustion engine. For example, the exposed heater element materials have to withstand the harsh environment of a typical internal combustion engine, such as EGR (exhaust gas recirculation) gases, PCV (positive crankcase ventilation) gases, and in case of ethanol fuel, alcohol. Alcohol is known to induce corrosion on many metals.

Furthermore, application of the vaporization through spraying a liquid fuel directly on a heated surface can currently not be easily implemented since electrical connections must maintain the hermetic seal that exists between the air intake ductwork and ambient air. Still further the actual heater element must be retained in case of a failure, such that parts of the heating element may not enter the air intake stream of the engine should the heater deteriorate for any reason, which is not enabled by prior art fuel vaporization methods.

U.S. Pat. No. 4,860,434 discloses a multi-layer self-vulcanizing flat electrical resistance heating element, where a metal sheet is sandwiched between two layers. Those two layers may be felted layers of ceramic material impregnated with a resin polymerisable under action of heat, layers based on alumina and projected in the form of plasma, or layers of enamel. A drawback of this approach is the use of multiple layers that may separate during application.

U.S. Pat. No. 6,269,876 discloses a heating element made from a porous metal sheet. While this heating element can be designed to have a high heat flux, the open areas in the material surface make the heating element prone to corrosion. The heating elements could be coated with a more corrosive restive metal surface, which would increase the manufacturing costs.

What is needed in the art is a heating element suitable for vaporizing liquid fuel and, therefore, enhancing the cold-starting capability and emission reduction of a port-injected, direct injected, or carbureted internal combustion engine, and especially a spark-ignited engine.

It is a principal object of the present invention to increase the ease and reliability of starting such an engine at relatively low ambient fuel and air temperatures.

It is a further object of the invention to enable vaporization of liquid fuel at a higher performance and at a fraction of the cost compared to current technologies.

### SUMMARY OF THE INVENTION

Briefly described, a heated fuel vaporizer is disposed in an intake component, such as a throttle valve assembly or an intake manifold, of a fuel injected and spark-ignited internal combustion engine that is fueled by liquid fuels, such as gasoline, diesel, or fuels that are much less volatile than gasoline, for example, alcohols such as ethanol, or mixtures of ethanol and gasoline. The object of the heated fuel vaporizer is to enrich the air passing through the intake component with vaporized fuel such that, upon compression within the cylinders, an explosive air/fuel mixture is created that can be discharged by a sparking plug.

The heated fuel vaporizer in a first aspect of the invention includes a heating element made from a single piece of sheet metal, preferably stainless steel. By using stainless steel, the heating element in accordance with the invention is able to withstand the harsh environment of a typical internal combustion engine, which may not be the case for prior art heating elements. The heating element in accordance with the invention can either be a single-grid or a dual-grid heating element. By controlling the geometry of the element, the power and surface area can be configured to any desired value. The heating element in accordance with the invention has a controllable heat flux that can reach and exceed about 5 W/mm². The high power to specific heat ratio of the design of the heating element in accordance with the present invention results in higher performance compared to prior art heating elements and “instant on” operation of the device with no preheating required. Stamped from sheet metal, the heating element can be made relatively stiff eliminating the need for a frame or supporting structure and can be manufactured at lower cost than current technologies. Although detailed description of the preferred embodiment herein will be directed to an automotive application, it is understood that the heating element, single-grid and dual-grid design, is useful in other applications that would profit from a low cost, high power heating element, such as industrial heaters, space heaters, dishwashers, hairdryers, ovens, and toasters.

In another aspect of the invention, the heated fuel vaporizer includes a single piece snap in heater assembly for installation in an intake component, such as throttle valve or intake manifold, of an internal combustion engine. The heater assembly includes a single piece stamping that is an integral piece including terminals and a heating element. The single piece stamping is over-molded with a high melting temperature polymer. The design of the heater assembly eliminates the need for solder or mechanical connections to be attached to the heating element. The heater assembly also integrates retaining features that prevent debris of the heating element to enter the engine in case of a malfunction. The over molded polymer geometry is designed to provide a hermetic seal between outside air and the air intake ductwork. By integrating these features, problems associated with prior art vaporizers can be eliminated. The simplistic design of the heater assembly in accordance with the invention provides a universal part that can be implemented in a plurality of engine applications and further provides simplified servicing and replacement capability compared to prior art heater assemblies.

### BRIEF DESCRIPTION OF THE DRAWINGS

The present invention will now be described, by way of example, with reference to the accompanying drawing, in which:

FIG. 1 is a schematic plan view of a first embodiment of a single-grid heating element in accordance with the invention;

FIG. 2 is a schematic plan view of a second embodiment of a single-grid heating element in accordance with the invention;

FIG. 3 is a schematic plan view of an outspread dual-grid heating element in accordance with the invention;

FIG. 4 is an isometric view of a bent dual-grid heating element in accordance with the invention:

FIG. 5 is an isometric view of a single piece heater assembly in accordance with the invention;

FIG. 6 is a cross-sectional view taken through the center of a single piece heater assembly in accordance with the invention; and

FIG. 7 is a plan top view of the single piece heater assembly installed in an intake manifold in accordance with the invention.

Corresponding reference characters indicate corresponding parts throughout the several views. The exemplifications set out herein illustrate various possible embodiments of the invention, including one preferred embodiment in one form, and such exemplifications are not to be construed as limiting the scope of the invention in any manner.

### DESCRIPTION OF THE PREFERRED EMBODIMENTS

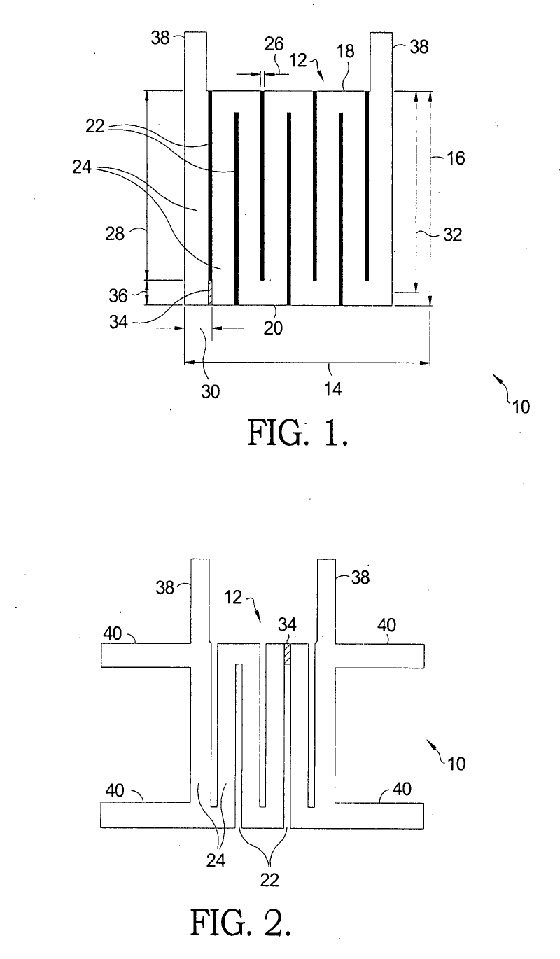

Referring to FIG. 1, a single-grid heating element 10 in accordance with the invention is manufactured from a single piece of sheet metal. Heating element 10 may be cut or stamped from a blank piece of sheet metal having an application specific length, width, and thickness. Theoretically, almost any metal can be used as long as the characteristics of the material are accounted for in the design of heating element 10. Steels and particularly stainless steels are the currently preferred materials for application in the automotive industry due to their ability to withstand the harsh environment of a typical internal combustion engine, such as EGR (exhaust gas recirculation) gases, PCV (positive crankcase ventilation) gases, and in case of ethanol fuel, alcohol. The design of the heating element utilizes the material characteristics of the sheet metal along with the geometry of the material to provide the required area and power of heating element 10 according to the application of heating element 10, for example, as fuel vaporizer for an internal combustion engine fueled by fuels much less volatile than gasoline, such as alcohols such as ethanol, or mixtures of ethanol and gasoline. Other applications of heating element 10, for example, as industrial heaters, space heaters, dishwashers, hairdryers, ovens, and toasters may be possible.

Heating element 10 has a width 14 and a length 16. The thickness (not shown) of heating element 10 depends on the thickness of the sheet metal used. Length 16 is measured from a first side 18 to a second side 20. The thickness is preferably constant over the entire surface area of the single piece of sheet metal. Heating element 10 includes a number of slots 22 to form a series path of segments 24. Slots 22 and segments 24 form a grid 12 having a surface area. Each slot 22 has a width 26 and a length 28. Each segment 24 has a width 30, and an average length 32 and a thickness. Slots 16 are formed, for example by cutting or stamping, into the sheet metal in an alternating fashion from first side 18 and opposite second side 20 and extend for a length 28 preferably along the longest dimension, such as length 16 of heating element 10 as shown in FIG. 1. By forming slots 22 along the longest dimension of heating element 10, a smaller number of slots 22 is required than forming slots 22 along the shortest dimension, although this can be done if desired. Slots 22 are formed into the sheet metal such that a connection area 34 is formed. The dimensions of the sheet metal (length 16, width 14, and thickness), the dimensions (width 26 and length 28) and number of slots 22 determine the power and surface area of grid 12 and, therefore, of heating element 10.

Connection area 34 is a relatively small piece of sheet metal at the end of each slot 22 that connects one segment 24 to an adjacent segment 24. Connection area 34 is a bridging piece of sheet metal that has preferably the same length 36 as the width 30 of segment 24 and thereby prevents current crowding in the connection area 34, which results in a relatively uniform heat flux over the entire surface area of heating element 10.

Specifically the length 16, the width 14, and the thickness of the sheet metal along with the number of slots 22, the length 28 and the width 26 of slots 22, and the placement of the slots 22 determine the electrical characteristics of heating element 10 and can be configured according to a desired application. A higher number of slots 22 will raise the resistance and lower the power of heating element 10. An odd number of slots 22 results in electrical connections on the same side, such as first side 18 as shown in FIG. 1, of heating element 10 while an even number of slots 22 results in electrical connection on opposite sides, such as first side 18 and second side 20 shown in FIG. 1, of heating element 10.

As shown in FIG. 1, electrical connection tabs 38 that extend from the first and last segment 24 of grid 12, such that connection tabs 38 are part of a resistive path formed by segments 24. Connection tabs 38 are used to electrically connect heating element 10. Connection tabs 38 may be formed as, but are not limited to, pins that fit into an electrical connector (not shown) for termination or may be otherwise connected to an electrical connector. The connection tabs 38 are integrated in the single piece of sheet metal and form a monolithic part with grid 12. Therefore, the thickness of connection tabs 38 is equal to the thickness of segments 24.

Additional features, for example, mounting tabs 40 as shown in FIG. 2, may be added to heating element 10. Although not being part of the resistive path formed by segments 24, mounting tabs 40 may be integrated in the single piece of sheet metal to form a monolithic part with grid 12. Mounting tabs 40 are used to mount heating element 10 to an application device, such as an intake manifold or a backer and are not limited to the size or shape shown in FIG. 2. Mounting tabs 40 may be positioned at any side of heating element 10 as long as there is no interference with electrical connectors 38. Even though there are four mounting tabs 40 shown in FIG. 2, any number of mounting elements 40 may be used according to the application of heating element 10.

When heating element 10 is used as a fuel vaporizer for an internal combustion engine fueled by low-volatility fuels, such as alcohols (e.g. ethanol), or mixtures of alcohol and gasoline, heating element 10, which is typically sprayed with fuel 308 (FIG. 7) having a relatively cold temperature, may be configured to have a relatively high heat flux, for example, at or above about 5 W/mm². To prevent melting of heating element 10 when operated without spraying fuel 308 (FIG. 7) onto the heated surface area of grid 12, a safety device (not shown) in the form of a thermistor, PTC fuse or other temperature sensing device may be attached to heating element 10 to detect and monitor the temperature of heating element 10. The obtained information can be used to interrupt current to heating element 10 to protect heating element 10 either directly or through a control relay or transistor.

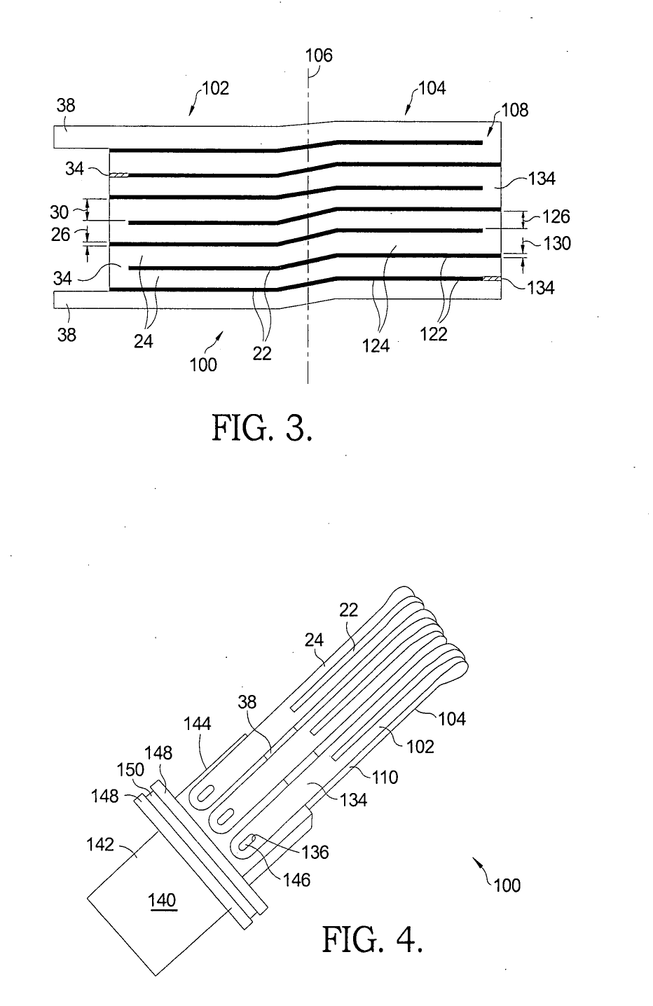

While heating element 10 illustrated in FIGS. 1 and 2 is shown as a single-grid heating element that includes only a single grid 12 formed by slots 22 and segments 24, heating element 10 may be designed as a dual-grid heating element 100 as shown in FIGS. 3 and 4.

Referring now to FIGS. 3 and 4, dual-grid heating element 100 includes a first grid 102 formed by slots 22 and segments 24 and a second grid 104 formed by slots 122 and segments 124. First grid 102 and second grid 104 are formed, for example by cutting or stamping, from a single piece sheet metal 12 as a monolithic part. FIG. 3 shows heating element 100 as formed from a single piece sheet metal 108. For application, dual-grid heating element 100 is bent at a bend axis 106. Bend axis 106 also separates first grid 102 from second grid 104. Slots 22 go continuously over into slots 122. In the transition area between slots 22 and 122 proximate to bend axis 106, the slots are angled to change the position of slots 122 in grid 104 relative to the position of slots 22 in grid 102. When heating element 100 is bent along bend axis 106, first grid 102 is arranged in front of second grid 104 such that segments 124 are positioned behind slots 22. First grid 102 and second grid 104 may be folded to a “U” shape” (shown in FIG. 4). First grid 102 and second grid 104 are electrically in series. There is a gap 110 (FIG. 4) between first grid 102 and second grid 104 to prevent electrical shortening. By integrating two-grids, first grid 102 and second grid 104, in a monolithic part and by bending the part, the surface area of heating element 100 can be increased compared to the surface area of heating element 10 without increasing the overall size of heating element 100 compared to heating element 10.

First grid 102 includes a number of slots 22 to form a series path of segments 24 as described above for FIG. 1. Second grid 104 includes a number of slots 122 to form a series path of segments 124. Each slot 122 has a width 126. Each segment 124 has a width 130. Electrical connection tabs 38 may extend from first grid 102 as described above. First grid 102 and second grid 104 may further include, if desired for the application, mounting tabs (not shown) similar to mounting tabs 40 shown in FIG. 2.

Slot width 126 and, therefore segment width 130, of second grid 104 may be the same or may differ from the slot width 26 and segment width 30 of first grid 102. Consequently, second grid 104 may have electrical characteristics that are different from the electrical characteristics of first grid 102. An odd number of slots 22 and 122 is preferred for dual-grid heating element 100, such that electrical connection tabs are on the same side of both first grid 102 and second grid 104.

As shown in FIG. 4, dual grid heating element 100 may be attached to a structure 140. Structure 140 includes a disc 148 that may be designed to be received by a mating receptacle, such as mounting boss 302 of housing 300 as shown in FIG. 7, and is made preferably from a polymer material. Disc 148 may include a groove 150 that may receive an o-ring (not shown). Structure 140 may further include a socket 142 that houses electrical connection tabs 38 and may receive an electrical connector (not shown) providing power to heating element 100. Structure 140 may further include an extension 144 having retention features 146. Extension 144 is positioned on one side of disc 148 while socket 142 is positioned at the opposite side of disc 148. Structure 140 may be molded over heating element 100 such that electrical connection tabs 38 extend into socket 142 and such that apertures 136 included in extended connection areas 134 attach to retention features 146. Connection tabs 38 are positioned on one side of extension 144 opposite from extended connection areas 134 to ensure that first grid 102 and second grid 104 do not make contact.

When heating element 100 is used as a fuel vaporizer for an internal combustion engine fueled by low-volatility fuels, such as alcohols (e.g. ethanol), or mixtures of alcohol and gasoline, heating element 100 is typically sprayed with fuel 308 (FIG. 7) having a relatively cold temperature. By arranging first grid 102 and second grid 104 such that segments 124 of second grid 104 are aligned with slots 22 of first grid 102 positioned in front of second grid 104, fuel spray 308 (FIG. 7) that passes through slots 22 impinges on segments 124. The available surface area of dual-grid heating element 100 is thereby increased relative to the available surface area of single-grid heating element 10 and, thus, heat transfer to the liquid fuel is increased. In addition, the design of dual-grid heating element 100 allows an increase in overall resistance compared to single-grid heating element 10 such that a targeted resistance may be achieved while a large cross-sectional area of the segments 24 and 124 may be maintained.

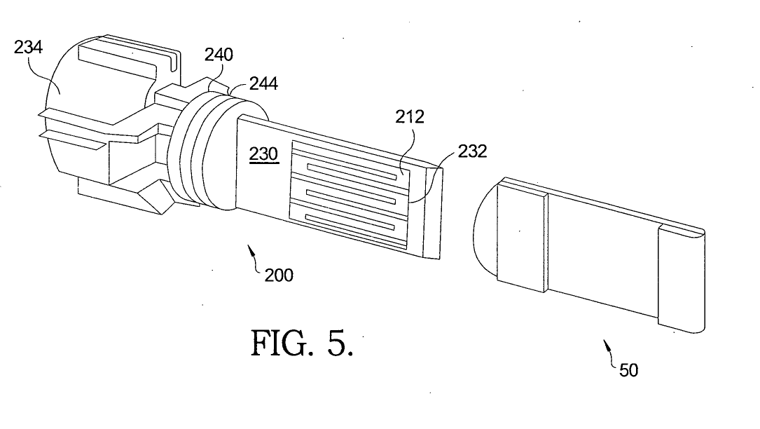

For application of heating element 10 (FIGS. 1 and 2) and heating element 100 (FIGS. 3 and 4) as ethanol vaporizer for an internal combustion engine, a backing plate 50, for example as shown in FIG. 5, may be positioned behind single-grid heating element 10 or behind second grid 104 of dual-grid heating element 100 opposite from the surface sprayed with the fuel 308 (FIG. 7). Backing plate 50 may be sized to cover the entire surface area of grid 12 of heating element 10 or of second grid 104 of heating element 100. Backing plate 50 may be manufactured from a material that is electrically insulating but thermally conducting.

When used in conjunction with single-grid heating element 10, backing plate 50 will receive fuel spray 308 (FIG. 7) that passes through slots 22. Due to surface tension, the fuel 308 (FIG. 7) will cling to the backing plate providing a chance for heating element 10 to heat up again after being cooled down by the fuel spray 308 (FIG. 7) and to vaporize at least some of the fuel retained by backing plate 50. Therefore, backing plate 50 may enlarge the surface area of heating element 10. Thus, vapor generation and thermal efficiency may be increased when a backing plate 50 is used.

When used in conjunction with dual-grid heating element 100, backing plate 50 may prevent overheating of second grid 204 positioned behind first grid 102 in the direction of the fuel spray 308 (FIG. 7) by retaining liquid fuel that passes through second grid 204. Therefore, first grid 102 may be designed by choosing slot width 26 and segment width 30 to withstand just the amount of power needed to achieve vaporization. Second grid 104 may be designed to receive a higher power than first grid 102, since backing plate 50 positioned behind second grid 104 may prevent overheating of second grid 104 at the higher power. This can be achieved by changing slot width 126 and segment width 130 compared to slot width 26 and segment width 30.

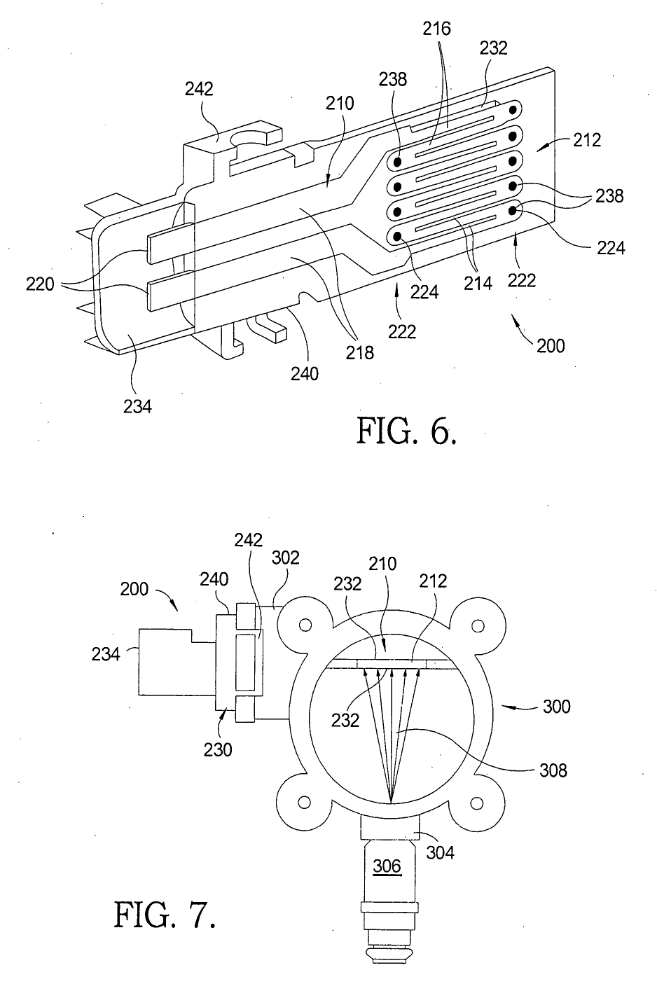

Referring now to FIGS. 5 and 6, a single piece heater assembly 200 includes a heating element 210 and a casing 230 that is over-molded over heating element 210. Even though, heating element 210 is shown as a single-grid heating element such as heating element 10 as shown in FIGS. 1 and 2 and as described above, heating element 210 may be a dual-grid heating element such as heating element 100 as shown in FIGS. 3 and 4 and as described above. Heating element 210 is made from a single piece of sheet metal having preferably a constant thickness and includes a grid 212 formed by slots 214 and segments 216 as well as electrical connection tabs 218. By designing electrical connection tabs 218 to be integral with grid 212, there is a continuous thickness in the transition area from grid 212 to electrical connection tabs 218 since the need for solder or mechanical connections to be attached to the heating element 210 can be eliminated. Ends 220 of electrical connection tabs 218 may be formed as pins that fit into an electrical connector for termination. The sheet metal is preferably a stainless alloy or may be ceramic coated in the surface area of grid 212. Grid 212 may have retaining features 222 integrated. Retaining features 222 may be relatively small pieces of sheet metal that protrude out from the perimeter of grid 212 at the end of each slot 214. Retaining features may be extended connection areas 34 (FIG. 1). Each retaining feature 222 may include an aperture 224.

Casing 230 is made from a polymer material having a high melting temperature. The polymer material may be, for example, an injection moldable phenolic. The polymer is over-molded over heating element 210 such that only grid 212 and ends 220 of electrical connection tabs 218 are not covered with the polymer material. Thus, casing 230 includes two windows 232 (front and rear) that expose grid 212 to the environment. When over-molding heating element 210 with the polymer, the polymer will fill apertures 224 of retaining features 222. Posts 238 are formed in apertures 224 from the polymer material during the over-molding process. Consequently, segments 216 are held in place by posts 238. Thus, should a segment 216 crack or break, both ends of the segment 216 will be retained by posts 238 and will be kept from falling away from assembly 200. Apertures 224 in combination with posts 238 keep segments 216 attached to casing 230 even in the case of a damaged grid 212 due to a malfunction of heating element 210. Therefore, apertures 224 in combination with posts 238 prevent the engine from ingesting debris that may be generated during a malfunction of heating element 210.

Casing 230 may further include a socket 234. Ends 220 of electrical connection tabs 218 extend into socket 234. Socket 234 may be designed to receive an electrical connector (not shown) that receives ends 220 of electrical connection tabs 218 for providing power to grid 212.

Casing 230 still further includes a section 240 positioned adjacent to socket 234. The outer geometry of section 240 is designed such that heater assembly 200 can be received by a mating receptacle of an engine intake component, such as a throttle valve assembly or an intake manifold. Section 240 is designed to be received by the mating receptacle, such as a mounting boss 302 of a housing 300 as shown in FIG. 6, such that a hermetic seal between ambient air and air intake ductwork is provided. Section 240 may include a groove 244 for receiving an o-ring. By forming casing 230 from a polymer material, mating with an engine intake component is simplified since engine intake components typically are manufactured from high melting temperature polymer materials.

Casing 230 may also include a connecting feature 242. Connection feature 242 secures heater assembly 200 to mating boss 302. Connection feature 242 may be, for example, a snap-on feature as shown in FIGS. 6 and 7 and may be positioned adjacent socket 234 and section 240. The snap-in design as shown in FIG. 5 achieved by connection feature 242 also provides simplified servicing and replacement capabilities for the heater assembly 200.

Backing plate 50, for example, as shown in FIG. 5, may be designed as a slip cover that may be slipped over the portion of casing 230 that houses grid 212 such that backing plate 50 is positioned behind heating element 210 opposite from the surface sprayed with the fuel 308 (FIG. 7). Single piece heater assembly 200 may be used with or without backing plate 50 installed according to the application.

Referring now to FIG. 7, the heater assembly 200 is shown installed in a housing 300 as a fuel vaporizer in accordance with the invention. In a preferred embodiment, housing 300 is an intake manifold that is part of an internal combustion engine fueled by ethanol. Housing 300 may be a stand-alone component mounted to an intake manifold or may be integrated into the intake manifold. The housing 300 includes a mounting boss 302 that receives heater assembly 200 and a mounting boss 304 that receives a fuel injector 306. Fuel injector 306 sprays fuel 308 into housing 300 where it comes in contact with heating element 210, which is integrated in heater assembly 200 and positioned perpendicular to the direction of the fuel spray 308 and is vaporized due to the heat produced by heating element 210. In order to vaporize as much fuel 308 as possible, heating element 210 may be arranged in heater assembly 200 such that slots 214 extend perpendicular to the spray of fuel 308. Mounting boss 304 for fuel injector 306 and mounting boss 302 for heater assembly 200 are located to each other in such a way that most of the spray 308 delivered from injector 306 impinges on substantially all of the surface area of grid 212 of heating element 200. This targeting scheme maximizes vaporization of the fuel and minimizes engine start duration, while assuring uniform coverage of heating element 210. The position of mounting bosses 302 and 304 may be adjusted based on spray 308 geometry of injector 306 utilized in a specific application, and actual differences in air ductwork geometry from one engine application to another. The efficiency of fuel vaporization by heating element 210 may be further improved by attaching a backing plate 50 (FIG. 5) to heater assembly 200. Backing plate 50 may be attached to the side of heater assembly 200 that is facing away from fuel injector 306 and such that the surface area of rear window 232 of heater assembly 200 is covered. Backing plate 50 may be attached to heater assembly 200 using a snap-on or a sliding mechanism. While heater assembly 200 has been shown and described for application as fuel vaporizer in an intake manifold of an internal combustion engine, heater assembly may be implemented in almost any engine application provided that the proper mounting boss geometry can be implemented into existing hardware.

While heating elements 10 and 100, as well as heater assembly 200 have been mainly described as being advantageous for fuel vaporization of low-volatile liquid fuels, heating elements 10 and 100, as well as heater assembly 200 may also be advantageous for fuel vaporization of other liquid fuels, such as gasoline and diesel, for example, to enhance overall emission reduction.

It should be understood that numerous changes may be made within the spirit and scope of the inventive concepts described, including but not limited to other configurations, materials, and locations of vaporization elements. Accordingly, it is intended that the invention not be limited to the described embodiments, but will have full scope defined by the language of the following claims.

What is claimed is:

1. A configurable heating element; comprising:
a single piece of sheet metal;
a plurality of slots formed into said sheet metal; and
a serial path of segments defined by said slots, said slots and said segments forming a grid having a surface area;
wherein dimensions of said sheet metal and dimensions and number of said slots determine power and said surface area of said grid.

2. The configurable heating element of claim 1, further including electrical connection tabs extending from said grid and being integrated in said single piece of sheet metal, wherein said connecting tabs are part of a resistive path formed by said segments.

3. The configurable heating element of claim 2, wherein said connection tabs are formed as pins for termination to an electrical connector.

4. The configurable heating element of claim 1, further including mounting tabs extending from said grid and being integrated in said single piece of sheet metal, wherein said mounting tabs are not part of a resistive path formed by said segments.

5. The configurable heating element of claim 1, wherein said dimension of said sheet metal include a length, a width, and a thickness, wherein said length is the longest of said dimensions, and wherein said slots are positioned along said longest dimension.

6. The configurable heating element of claim 1, wherein said dimensions of said slots include a length and a width, wherein said length, said width, and the number of said slots determines dimensions of said segments.

7. The configurable heating element of claim 1, wherein said slots are formed into said sheet metal forming a connection area, wherein said connection area is a bridging piece of said sheet metal that connects one of said segments with an adjacent one of said segments, and wherein a length of said connection area is equal to a width of said segments.

8. The configurable heating element of claim 1, wherein an odd number of slots is formed into said sheet metal forming an even number of segments, and wherein electrical connection tabs extend from the first of said segments and the last of said segments in the same direction.

9. The configurable heating element of claim 1, wherein a higher number of said slots raises the resistance and lowers the power of said heating element compared to a lower number of said slots.

10. The configurable heating element of claim 1, further including an additional grid formed into said sheet metal, wherein said grid is arranged in front of said additional grid, and wherein said slots are aligned with segments of said additional grid

11. A dual-grid configurable heating element assembly for application as fuel vaporizer in an internal combustion engine fueled by liquid fuels, comprising:
a first grid formed by a plurality of first slots and a plurality of first segments;
a second grid formed by a plurality of second slots and a plurality of second segments and being electrically in series with said first grid;
a bend axis separating said first grid from said second grid; and
a single piece of sheet metal; wherein said first grid and said second grid are formed from said single piece of sheet metal as a monolithic part;
wherein said heating element is bent at said bend axis, wherein said first grid is arranged in front of said second grid, and wherein said second segments are positioned behind said first slots.

12. The dual-grid configurable heating element of claim 11, further including electrical connection tabs and mounting tabs, wherein said electrical connection tabs extend from said first grid, are integrated in said single piece of sheet metal, and connect said heating element to an electrical connector for termination, and wherein said mounting tabs are integrated in said single piece of sheet metal and attach said first grid and said second grid to an application device.

13. The dual-grid configurable heating element of claim 11, wherein said first slots have a width that is equal to a width of said second slots, and wherein said first grid has electrical characteristics that are equal to electrical characteristics of said second grid.

14. The dual-grid configurable heating element of claim 11, wherein said first slots have a width that is different from a width of said second slots and wherein said first grid has electrical characteristics that are different from electrical characteristics of said second grid.

15. The dual-grid configurable heating element of claim 11, wherein said first grid and said second grid include an odd number of slots.

16. The dual-grid configurable heating element of claim 11, wherein a backing plate is positioned behind said second grid, wherein said backing plate covers substantially the entire surface area of said second grid, and wherein said backing plate is made from an electrically insulating material.

17. A single piece heater assembly for application as fuel vaporizer in an internal combustion engine fueled by liquid fuels, comprising:
a configurable heating element made from a single piece of sheet metal and including at least one grid having electrical connection tabs; and
a casing over-molded over said heating element, wherein said at least one grid and said electrical connection tabs are exposed.

18. The single piece heater assembly of claim 17, wherein said casing is made from an injection moldable polymer material.

19. The single piece heater assembly of claim 17, wherein said casing includes two windows that expose said at least one grid to the environment.

20. The single piece heater assembly of claim 17, wherein said casing further includes a socket, and wherein said electrical connection tabs extend into said socket.

21. The single piece heater assembly of claim 17, wherein said casing further includes a section having an outer geometry that is received by a mating boss of an intake component of said internal combustion engine, and wherein said casing further includes connection features that secure said casing to said intake component.

22. The single piece heater assembly of claim 17, wherein said grid includes a plurality of slots formed into said sheet metal and a serial path of segments formed by said slots, wherein dimensions of said sheet metal, and dimensions and number of said slots determine power and the surface area of said grid.

23. The single piece heater assembly of claim 17, wherein said heating element further includes retaining features having an aperture and protruding out from a perimeter of said grid at an end of each of said slots, wherein said polymer material fills said apertures and forms posts, and wherein said posts hold said segments of said grid in place.

24. The single piece heater assembly of claim 17, wherein said configurable heat element includes a first and a second grid formed from a single piece of sheet metal as a monolithic part, wherein said first grid is arranged in front of said second, wherein slots of said first grid are aligned with segments of said second grid.

25. The single piece heater assembly of claim 17, wherein a backing plate is attached to said casing covering one of said two windows and improving fuel vaporization by said heating element.
